(19) United States
(12) Patent Application Publication
(10) Pub. No.: US 2008/0300331 A1
(43) Pub. Date: Dec. 4, 2008

(54) Polymeric foam containing long carbon nano-tubes

(76) Inventors: Jurgen Schellenberg, Halle (DE); Petra Dehnert, Halle (DE); Barbara Erling, Halle (DE)

Correspondence Address: The Dow Chemical Company, Intellectual Property Section, P.O. Box 1967, Midland, MI, 48641-1967, US

(21) Appl. No.: 11/975,073

(22) Filed: Oct. 17, 2007

Related U.S. Application Data
(60) Provisional application No. 60/881,243, filed on Jan. 19, 2007.

(51) Int. Cl. C08J 9/00

(52) U.S. Cl. 521/82; 521/146; 977/752

(57) ABSTRACT

Prepare a polymer foam having cells defined by cell walls having an average thickness and carbon nano-tubes having a length that exceeds the average thickness of the cell walls by incorporating the carbon nano-tubes into expandable polymer beads in a suspension polymerization process and then expanding the expandable polymer beads into a polymer foam.

This application claims benefit of priority from U.S. Provisional Application Ser. No. 60/881,243, filed on Jan. 19, 2007.

### BACKGROUND OF THE INVENTION

1. Field of the Invention

The present invention relates to polymeric foam containing conductive fillers in the form of carbon nano-tubes, as well as the preparation and use of such foams.

2. Description of Related Art

Incorporation of electrically conductive fillers in polymer compositions is useful to create electrically conducting polymers. One particular type of electrically conductive filler is carbon nano-tubes. Carbon nano-tubes reportedly have remarkable mechanical and electronic properties due to their unique tubular structure and large aspect ratios (ratio of length to diameter).

One of the features that makes carbon nano-tubes remarkable—their large aspect ratio—also makes them challenging to incorporate into polymeric foam structures. Filler particles with such a high aspect ratio that their length exceeds the cell wall thickness of a target polymeric foam can rupture expanding cells and cause the polymer foam to collapse during expansion.

JP2005-139316A addresses the challenge of incorporating carbon nano-tubes into polymeric foam by disclosing an electrically conductive polymeric foam sheet containing carbon nano-tubes. However, consistent with the challenge of foaming a polymer containing a high aspect ratio filler, the foam sheets only have an expansion ratio of 1.5 to 20.

PCT publication WO 2006/114495A2 discloses a process for preparing polymer foam materials containing carbon nano-tubes that reportedly can achieve expansion ratios of 50-99. The reference discloses a three stage process. The first stage requires mechanically blending carbon nano-tubes into a polymer melt to form a mixture. The second phase is solubilization of a blowing agent into the mixture. The third phase is cell creation by expanding the blowing agent within the mixture. Mechanical blending of carbon nano-tubes into a polymer melt suffers from at least two handicaps: (1) homogeneous dispersion of the carbon nano-tubes in the polymer melt is nearly impossible; and (2) the mechanical process of mixing into a polymer melt tends to break the carbon nano-tubes up into shorter pieces. Therefore, it is unlikely that the disclosed process of WO 2006/114495A2 produces a foam containing CNTs with a length that exceeds the foam's cell wall thickness—a conclusion supported by FIG. 4 of the reference.

It is desirable to employ the properties of carbon nano-tubes into lower density foams than JP2005-139316A in order to enhance the thermal insulating properties of the foam while achieving electrical conductivity to mitigate static charge build up. It would also advance the art to prepare a low density foam that contains carbon nano-tubes that are longer than the foam's average cell wall thickness in order to maximize the benefit from the carbon nano-tube's large aspect ratio.

### BRIEF SUMMARY OF THE INVENTION

The present invention surprisingly provides a polymer foam having an expansion ratio greater than 20 and carbon nano-tubes having an length that exceeds the average cell wall thickness of the foam. The present invention provides for a thermally insulating foam that is electrically conductive to mitigate static charge build up.

In a first aspect, the present invention is a polymer foam comprising multiple expanded beads of a thermoplastic polymer, the foam having cells defined therein by cell walls having an average cell wall thickness, wherein the foam has an expansion ratio of more than twenty and contains carbon nano-tubes that have a length greater than the average cell wall thickness. Preferred embodiments of the first aspect include one or more of the following features: the thermoplastic polymer contains alkenyl aromatic polymer units; the thermoplastic polymer contains styrene homopolymer; the foam has an expansion ratio of fifty or more, or 100 or more; the carbon nano-tubes have a diameter of one nanometer or more and 100 nanometers or less; the carbon nano-tubes are multiwalled carbon nano-tubes; the carbon nano-tubes are present at a concentration of 0.05 to 1 weight-percent based on total foam weight; and the carbon nano-tubes are homogeneously distributed in the thermoplastic foam.

In a second aspect, the present invention is a process for preparing the foam of the first aspect comprising the steps of: (a) preparing an expandable polymer composition comprising a thermoplastic polymer, carbon nano-tubes and a blowing agent by suspension polymerization; and (b) expanding the expandable polymer composition into a foam with cells defined by cell walls having an average thickness, the expansion developing an expansion ratio of more than twenty, wherein the carbon nano-tubes have lengths that are greater than the average cell wall thickness. Preferred embodiments of the second aspect include one or more of the following features: the thermoplastic polymer comprises alkenyl aromatic monomer units; the blowing agent is selected from hydrocarbons having from three to six carbons; step (b) includes expanding the polymer beads using steam; step (b) involves two different expansions the second of which occurs within a mold; the carbon nano-tubes have diameters of 100 nanometers or less; the carbon nano-tube is a multiwalled carbon nano-tube; the carbon nano-tubes are present at a concentration of 0.05 to 1 weight-percent based on total expandable polymer composition weight; and the expansion develops an expansion ratio of fifty or more.

In a third aspect, the present invention is a method for using the foam of claim 1 comprising the step of placing the foam between two spaces such that the foam creates a barrier between the two areas that inhibits energy transfer from one area to the other area.

### DETAILED DESCRIPTION OF THE INVENTION

### Process for Preparing the Polymer Foam

Prepare foams of the present invention from an expandable polymer composition comprising a thermoplastic polymer, a blowing agent and carbon nano-tubes (CNTs).

Suitable thermoplastic polymers include olefinic homopolymers and copolymers containing polyethylene, polypropylene or both, as well as homopolymers and copolymers containing alkenyl aromatic monomer units (i.e., made from monomers that include alkenyl aromatic monomers). The most preferable thermoplastic polymers are polystyrene (PS) homopolymers and copolymers.

Prepare the expandable polymer composition in bead form by suspension polymerization. In its broadest scope, “bead” refers to particulate or granule form and does not imply any particular size or shape. However, suspension polymerization processes offer advantages over other methods of foaming polymer beads (e.g., extruding and cutting strands into particulates) by producing highly spherical beads which expand into a foam having a highly uniform appearance. Suspension polymerization processes are well known in the art (see, e.g., U.S. Pat. No. 5,591,778 incorporated herein by reference; and WO 2004/087798 page 8, line 7 through page 11, line 18 incorporated herein by reference). The present process is not limited to any particular general suspension polymerization process.

A suspension polymerization procedure is particularly desirable because it does not fracture the CNTs into shorter lengths. As a result, polymer foams prepared from the expandable polymer compositions can contain long CNTS, even CNTs having an length greater than the average cell wall thickness of the polymer foam.

In general, conduct a suspension polymerization process by suspending monomer in an aqueous or other non-reactive (non-polymerizing with suspended monomers) medium and then polymerize the monomer into polymer beads. Monomers can be any monomer or combination of monomers that form a thermoplastic polymer upon polymerization. Olefinic and alkenyl aromatic monomers are desirable. Ethylene, propylene and styrenic-based monomers (e.g., styrene and styrene copolymers) are most desirable. The polymer beads comprise homopolymer or copolymers of the polymerized monomers. Desirable polymers include homopolymers and copolymers of ethylene, propylene, and styrene.

Blowing agent is usually added during polymerization. However, it is also possible to add blowing agent to polymer beads after the polymerization step. Blowing agents are generally selected from hydrocarbons having from three to six carbons, preferably an isomer of butane (e.g., isobutane and n-butane) or an isomer of pentane (e.g., isopentane and n-pentane).

The present process includes a unique step of adding CNTs to the suspension of monomer in aqueous or other non-reactive phase prior to polymerizing. In such a process, the CNTs intimately incorporate into the polymerized polymer beads in a more homogeneous manner than is likely to occur by mechanically blending the CNTs into a polymer composition after polymerization. Also, the present process allows CNTs having a relatively long length (e.g., longer than the average cell wall thickness of a foam prepared from the expandable polymer composition) to be intimately incorporated within the expandable polymer composition since a suspension polymerization process does not tend to fracture the long CNTs.

CNTs are unique structures that can offer benefits to polymer foam, but can also present challenges in forming polymer foam. See, e.g., PCT publication WO2004/046031 (incorporated herein by reference) for teaching about CNTs. According to the PCT publication, “[c]arbon nano-tubes are self assembled coaxial cylindrical graphene sheets of sp² hybridized carbon atoms. Because of their unique tubular structure and large aspect ratios (length vs. diameter), they have remarkable mechanical and electronic properties.” (see paragraphs 4-7). CNTs have advantages over carbon fibers due to kink-like ridges in their structure which allow the nano-tube to experience compression and relaxation without fracturing. The PCT publication also points out the difficulties of implementing CNT into polymer compositions (see paragraphs 10 and 11).

The CNTs of the present invention can be single-walled or multi-walled. Multi-walled CNTs are more desirable because they have a greater wall thickness and stiffness than single-walled CNTs. Greater stiffness is desirable to preserve the CNTs from fracturing while preparing polymer foam and to serve as better reinforcing components within the polymer foam.

An inherent feature of CNTs is their high aspect ratio. The process and foam of the present invention contain CNTs that have a length greater than the average cell wall thickness of the foam. Generally, that means the process and foam contain CNTs having a length of more than 0.5 micrometers (μm), typically of 10 μm or more, more typically of 100 μm or more, even 200 μm or more. Generally, the length of the CNTs will be 600 μm or less. Often, CNTs will have a range of lengths that include at least a portion that have the specified length. CNTs generally have an outer diameter of one nanometer (nm) or more, typically 10 nm or more, and generally 100 nm or less.

CNTs are desirably present in the expandable polymer composition at a concentration of 0.001 weight-percent (wt %) or more in order to realize benefits from their presence. Preferably CNTs are present at a concentration of 0.01 wt % or more, more preferably 0.05 wt % or more, still more preferably 0.1 wt % or more and can be present at a concentration of 1 wt % or more. Higher concentrations of CNTs are desirable to increase the electrical conductivity or the stiffness of the resulting polymer foam. Generally, CNTs are present at a concentration of 10 wt % or less. If the concentration of carbon nano-tubes exceeds 10 wt % foaming becomes undesirably difficult. Determine wt % of CNTs relative to total weight of the expandable polymer composition.

Generally, expand the expandable polymer composition into a polymer foam by softening the expandable polymer composition and allowing the blowing agent to expand into void spaces (cells) within the polymer composition. Typically, expand a expandable polymer composition by exposing the expandable polymer composition to steam. Prepare a polymer foam of a desired shape by placing beads of the expandable polymer composition into a mold of a desired shape, exposed to steam to soften and expand the polymer composition to fill mold and then cool and release the resulting foam from the mold. The expandable polymer composition expands to an expansion ratio of twenty or more, preferably 50 or more and can expand to an expansion ratio of 100 or more. An expansion ratio is the volume of the resulting (final) foam divided by the volume of the polymer composition before any expansion.

Surprisingly, the process of the present invention is suitable to prepare polymer foam having an expansion ratio of more than 20, preferably 25 or more, even more preferably 50 or more, even 100 or more while concomitantly containing CNTs having a length greater than the polymer foam's average cell wall thickness. Such a polymer foam is another aspect of the present invention.

### Polymer Foam

The polymer foam of the present invention is an expanded polymer bead foam that contains CNTs having a length greater than the average cell wall thickness of the polymer foam. A characteristic of polymer bead foam is a polymer network extending continuously throughout the bead foam that encompasses each expanded bead like a skin. This polymer “skin” corresponds to the outer surface of each bead. These skins coalesce or adhere to one another in order to form an expanded bead foam. A further characteristic of the polymer foam of the present invention is that it contains CNTs that have a length greater than the average cell size of the polymer foam.

The polymer foam of the present invention can comprise any thermoplastic polymer. Suitable thermoplastic polymers include olefinic homopolymers and copolymers containing polyethylene, polypropylene or both. The thermoplastic polymer desirably is a homopolymer or copolymer containing alkenyl aromatic monomer units (i.e., made from monomers that include alkenyl aromatic monomers). The most desirable thermoplastic polymers are polystyrene (PS) homopolymers and copolymers.

The polymer foam has cells defined within the thermoplastic polymer by cell walls that have an average thickness. The cells constitute space within cell walls in which a blowing agent resided during expansion. Cell walls comprise thermoplastic polymer. The cell walls have an average thickness that is generally 0.8 micrometers (μm) or less, preferably 0.6 μm or less and can be 0.4 μm or less. There is no known minimum average thickness for the cell walls. It is conceivable that a cell wall can be a membrane only as thick as a single molecular dimension. Determine average cell wall thickness by scanning electron microscopy of a polymer foam cross section.

Polymer foams of the present invention can be either open or closed cell. Closed cell foams have an open cell content of less than 30 percent (%), preferably 20% or less, more preferably 10% or less, still more preferably 5% or less and can have 0% open cell content. Open cell foams have an open cell content of 30% or more, typically 50% or more, more generally 80% or more. Open celled foams can have an open cell content of 90% or more, 95% or more, or even 100%. Open cell content is a measure of how many cells are connected to an adjacent cell by an opening in a cell wall between the adjacent cells. Measure open cell content according to American Society for Testing and Materials (ASTM) method D6226-05. Foams of the present invention are desirably closed cell foams since closed cell foams are generally better thermal insulators than open cell foams.

Cells generally have an average cell size of 20 μm or more, desirably 60 μm or more and generally 500 μm or less, more typically 300 μm or less. Determine average cell size according to ASTM method D-3576.

Cells occupy greater than ninety-five percent of the total foam volume. The percent foam volume that cells in a foam occupy (i.e., percent cell volume) corresponds to an expansion ratio for the foam. Expansion ratio is the volume of final foam divided by volume of foamable composition. The foamable composition comprises all of the components required to expand a foam prior to actually expanding into a foam. Expansion ratio and percent foam volume that cells occupy correspond to one another in accordance with equations (1) and (2):

Percent Cell Volume=100(1−1/(Expansion Ratio)) (1)

Expansion Ratio=(100/(100−(Percent Cell Volume))) (2)

Therefore, foams of the present invention have an expansion ratio of greater than 20. Foams of the present invention can have an expansion ratio of 25 or more (96% cell volume or more), 50 or more (98% cell volume or more), even 100 or more (99% cell volume or more). Generally, foams of the present invention have an expansion ratio of 200 or less (99.5% cell volume or less) in order to ensure mechanical strength and integrity.

CNTs in the polymer foam aspect of the present invention are as described under the process aspect of the present invention. The concentration of CNTs in the polymer foam is as described for the process aspect with wt % relative to total polymer foam weight.

Foams of the present invention may also contain from 0.1 to 15 wt % of additives in addition to the carbon nano-tubes. Typical additives include nucleators, coatings, thermal insulating enhancing agents (e.g. carbon black, metal flakes and graphite), and flame retardants.

### Use of Carbon Nano-Tube Foam

Polymer foams of the present invention have many practical uses. One particularly attractive use is as a thermally insulating material. The high expansion ratio of the foam offers appealing insulation properties. Presence of the carbon nano-tube filler further provides the foam with electrical conductivity properties, which are desirable to mitigate static charges on foam. Therefore, foam of the present invention is particularly useful as a thermal insulator where static build up is undesirable. For example, foams of the present invention are useful for thermally insulating sensitive electrical devices such as circuit boards.

Use foams of the present invention as a thermal insulator by placing the foam between two areas in order to create a barrier between the two areas that inhibits energy transfer from one area to another. Energy transfer in the form of thermal energy is of particular interest. Electrical energy transfer is also of interest. By electrically grounding the foam of the present invention it may also provide an electrical barrier of sorts between the two areas.

### EXAMPLES

The following examples serve to further illuminate specific embodiments of the present invention and not to define the full scope of the invention.

### Example 1

### Preparation of Expandable Polymer Beads

Prepare expandable polystyrene granules (“beads”) in the following manner. Prepare a polystyrene composition using a suspension polymerization procedure. At ambient temperature add to a stirred polymerization reactor: 896 grams (g) water; 15.0 g of a first solution of 5 wt % polyvinyl alcohol (by weight of first solution) in water; and a second solution of 0.65 g polyethylene wax (polyethylene wax A-C™ 3A; A-C is a trademark of Allied Signal Inc.); 4.48 g of hexabromocyclododecane, 12.0 g polystyrene (200,000 g/mol Mw), 0.6 g multiwalled carbon nano-tubes (length ranges from 0.5-200 μm, 20-30 nanometers (nm) outer diameter, 5-10 nm inside diameter) in 598 g of styrene. Initiate polymerization by increasing the temperature of the reactor to 95 degrees Celsius (° C.) over 90 minutes and then to 130° C. over another 240 minutes and maintaining a 130° C. temperature for 120 minutes to complete polymerization. When the reactor reaches a temperature of 50° C. add 1.12 g of 1,1,3,3-tetramethylbutyl peroxy-2-ethylhexanoate and 4.2 g of dicumyl peroxide. 200 minutes after beginning to heat the reactor add another 15.0 g of a solution of the 5 wt % polyvinyl alcohol in water. When the reactor reaches a temperature of 117° C. add 42.5 g of pentane. Allow the reactor to cool to near ambient temperature (below 30° C.) and then isolate the resulting expandable polymer beads. Table 1 provides properties of the resulting expandable polymer beads.

Foaming of Expandable Polymer Beads

Prior to foaming the expandable polymer beads coat them with a mixture of mono-, di- and tri-glycerides of higher fatty acids having a chain length of C8-C22 (e.g., Softenol products) at a concentration of 0.24 wt % based on weight of the expandable polymer beads. Prefoam the beads by treating them with steam at atmospheric pressure until reaching a desired density. Dry the beads for 24 hours at 70° C. and then conduct a second expansion of the expandable polymer beads within a block mold 50 centimeters (cm) by 25 cm by 25 cm in dimension using low pressure steam until reaching a pressure of 0.7 bar in the block mold. Remove the resulting article from the mold and store at 70° C. for 72 hours to obtain Example 1. Table 2 discloses properties of Example 1.

### Example 2

Prepare Example 2 in like manner to Example 1, with the following exceptions: (i) replace the carbon nano-tubes with a 0.6 g of a different carbon nano-tube having a length of 0.5-2 μm, an outer diameter of 20-50 nm and an inside diameter of 1-2 nm; (ii) include 1.12. g of 1,1,3,3-tetramethylbutyl peroxy-2-ethylhexanoate and 4.2 g of dicumyl peroxide in the styrene monomer at that start rather than waiting until the reactor reaches 50° C.; (iii) instead of adding two 15.0 g portions of 5% polyvinyl alcohol in water, add a 20.0 g portion for the first addition and a 10.0 g portion for the second addition; and (iv) add the pentane blowing agent when the reactor reaches 114° C.

Table 1 contains characterization of the expandable polymer beads for Example 2 and Table 2 contains the properties of Example 2. CNTs having length of 1.25 μm to 1.85 μm are evident in a scanning electron micrograph of Example 2.

### Example 3

Prepare Example 3 in like manner as Example 1, with the following exceptions: Prepare expandable foam bead by a suspension polymerization but using the following components and heating profile. At ambient temperature, add into a reactor containing 896 g water and 6.0 g of a solution of 5 wt % polyvinyl alcohol in water (wt % based on total solution) a second solution of 0.65 g polyethylene wax (polyethylene wax A-C™ 3A), 4.48 g hexabromocyclododecane, 12.0 g polystyrene (200,000 g/mol Mw) 0.176 g divinylbenzene, 0.9 g tert-amylperoxy 2-ethylhexylcarbonate and 4.19 g dibenzoyl peroxide in 538 g of styrene. Heat the reactor to 90° C. and leave at that temperature for 90 minutes. Then, heat the reactor to 115° C. for another 180 minutes. At a polymerization conversion of 42.5% add a pre-sonicated dispersion of 0.3 g of multiwalled carbon nano-tubes (same as in Example 1) in 60 g of styrene. 210 minutes after beginning initial heating add another 6.0 g of a 5 wt % solution of polyvinyl alcohol in water. 250 minutes after beginning initial heating add 42.5 g of pentane. Allow the reactor to cool and isolate the expandable polymer beads by filtration, centrifugation and drying under air. Characterization of the beads is present in Table 1.

Foam the expandable beads as in Example 1 to achieve Example 3. Table 2 discloses properties for Example 3.

### Comparative Example A

Prepare Comparative Example A in like manner as Example 2 except: (i) do not include any carbon nano-tubes; and (ii) use 2.66 g of 2,5-dimethyl 2,5-di(2-ethylhexanoylperoxy)hexane instead of the 1,1,3,3-tetramenthylbutyl peroxy-2-ethylhexanoate; and (iii) use 10.0 g of 5 wt % solution of polyvinyl alcohol in water for the initial addition of the polyvinyl alcohol solution. Table 1 discloses characteristics of the expandable beads for Comparative Example A. Table 2 discloses properties for Comparative Example A (Comp Ex A).

TABLE 1
Expandable Bead Properties

| | CNT | | | C-value by |
|---|---|---|---|---|
| | Concentration | Polystyrene | Polystyrene | sieve |
| | (wt % based on | Mn* | Mw** | analysis |
| | polystyrene) | (g/mol) | (g/mol) | (mm) |
| Example 1 | 0.1 | 74,100 | 165,700 | 0.65 |
| Example 2 | 0.1 | 74,200 | 165,900 | 0.8 |
| Example 3 | 0.05 | 53,300 | 141,800 | 1.0 |
| Comp Ex A | 0 | 66,900 | 158,300 | 0.88 |

*Mn is number average molecular weight
**Mw is weight average molecular weight

TABLE 2
Foam Properties

| | | | Average | Electrical Properties | | |
|---|---|---|---|---|---|---|
| | Foam | | Cell Wall | Specimen | | Volume |
| | Density | Expansion | Thickness | Thickness | Resistance | resistivity |
| | (g/cm³) | Ratio* | (nm) | (nm) | (Ohm) | (Ohm*cm) |
| Ex 1 | 0.0194 | 52 | 660 | 12.8 | 5.20 × 10¹² | 8.63 × 10¹³ |
| Ex 2 | 0.0214 | 47 | 360 | 12.50 | 1.50 × 10¹² | 2.55 × 10¹³ |
| Ex 3 | 0.018 | 56 | 530 | 12.70 | 1.6 × 10¹¹ | 2.68 × 10¹² |
| Comp | 0.020 | 50 | 780 | 9.90 | 2.10 × 10¹⁴ | 4.50 × 10¹⁵ |
| Ex A | | | | | | |

*based on expandable polymer composition density of one gram per cubic centimeter.

Each of Example 1-3 illustrate a polymer foam having an expansion ratio of more than 20 (actually, more than 40) and comprising 0.05 wt % or more carbon nano-tubes that have a length greater than the average cell wall thickness of the foam. A comparison of Examples 1-3 to Comparative Example A also illustrates that in each of Examples 1-3 the carbon nano-tubes have a higher electrical conductivity (lower resistivity) than a similar foam without the carbon nano-tubes. Example 1 and 3 further illustrate such a foam with an expansion ratio greater than 50.

1. A polymer foam comprising multiple expanded beads of a thermoplastic polymer, the foam having cells defined therein by cell walls having an average cell wall thickness, wherein the foam has an expansion ratio of more than twenty and contains carbon nano-tubes that have a length greater than the average cell wall thickness.

2. The foam of claim 1, wherein the foam is a closed-cell foam.

3. The foam of claim 1, wherein the thermoplastic polymer contains alkenyl aromatic monomer units.

4. The foam of claim 1, wherein the thermoplastic polymer contains polystyrene homopolymer.

5. The foam of claim 1, wherein the foam has an expansion ratio of fifty or more.

6. The foam of claim 1, wherein the foam has an expansion ratio of 100 or more.

7. The foam of claim 1, wherein the carbon nano-tubes have a diameter of one nanometer or more and 100 nanometers or less.

8. The foam of claim 1, wherein the carbon nano-tubes are multiwalled carbon nano-tubes.

9. The foam of claim 1, wherein the carbon nano-tubes are present at a concentration of 0.05 to 1 weight-percent based on total foam weight.

10. The foam of claim 1, wherein the carbon nano-tubes are homogeneously distributed in the thermoplastic polymer.

11. A process for preparing the foam of claim 1 comprising the steps of:
(a) preparing an expandable polymer composition comprising a thermoplastic polymer, carbon nano-tubes and a blowing agent by suspension polymerization; and
(b) expanding the expandable polymer composition into a foam with cells defined by cell walls having an average thickness, the expansion developing an expansion ratio of more than twenty,
wherein the carbon nano-tubes have lengths that are greater than the average cell wall thickness.

12. The process of claim 11, wherein the thermoplastic polymer comprises alkenyl aromatic monomer units.

13. The process of claim 11, wherein the blowing agent is selected from hydrocarbons having from three to six carbons;

14. The process of claim 11, wherein step (b) includes expanding the polymer beads using steam.

15. The process of claim 11, wherein step (b) involves two different expansions the second of which occurs within a mold.

16. The process of claim 11, wherein the carbon nano-tubes have diameters of 100 nanometers or less.

17. The process of claim 11, wherein the carbon nano-tube is a multiwalled carbon nano-tube.

18. The process of claim 11, wherein the carbon nano-tubes are present at a concentration of 0.05 to 1 weight-percent based on total expandable polymer composition weight.

19. The process of claim 11, wherein the expansion develops an expansion ratio of fifty or more.

20. A method for using the foam of claim 1 comprising the step of placing the foam between two spaces such that the foam creates a barrier between the two areas that inhibits energy transfer from one area to the other area.
